(19) United States
(12) Patent Application Publication
(10) Pub. No.: US 2026/0187857 A1
(43) Pub. Date: Jul. 2, 2026

(54) INFORMATION PROCESSING APPARATUS, CONTROL METHOD THEREOF, AND LEARNING APPARATUS

(71) Applicant: CANON KABUSHIKI KAISHA, Tokyo (JP)

(72) Inventors: Yuta HORIKAWA, Tokyo (JP); Takamasa TSUNODA, Tokyo (JP)

(21) Appl. No.: 19/426,724

(22) Filed: Dec. 19, 2025

(30) Foreign Application Priority Data
Dec. 26, 2024 (JP) 2024-231015

(51) Int. Cl. G06T 11/00; G06V 20/70

(52) U.S. Cl. CPC G06T 11/00; G06V 20/70

(57) ABSTRACT

An information processing apparatus obtains a captured image obtained by an image capturing apparatus that can control an angle of view; generates an image pair including a noisy image including noise in an image and a clean image in which noise is reduced in an image, based on a plurality of captured images shot with an identical angle of view; controls a plurality of image pairs corresponding to a plurality of angles of view different from each other so as to be generated by the generation unit; and adds a label that can uniquely identify each image pair to each of the plurality of image pairs.

### BACKGROUND

### Field of the Technology

The present disclosure relates to a technique of generating a data set used for machine learning.

### Description of the Related Art

In recent years, a method using a neural network (NN) has been actively developed in an image processing technique for improving image quality of images and moving images. For example, many methods using NN have been proposed also in noise reduction (denoise) for reducing noise included in an image to generate a clean image without noise. In such NN, learning is performed using a pair of a noisy image (image including noise) and a clean image (image without noise) corresponding to the noisy image. For example, a noisy image is given to an input, and the NN is learned so that an output approaches a clean image.

In learning of the NN, it is easy to obtain a high-quality noise reduction model by using an image shot in an actual operation environment. Japanese Patent Laid-Open No. 2022-29125 (Patent Document 1) discloses a system that separates a shot image obtained by actual shooting into a foreground image and a background image to accumulate them into a database, and generates a composite image in which the foreground image and the background image are combined. Shi Guo et al., “Toward Convolutional Blind Denoising of Real Photographs”, arXiv:1807.04686v2, 2019 (Non-Patent Document 1) discloses a method of generating a clean image by performing averaging processing on a large number of noisy images shot by actual shooting, and using a pair of the noisy image and the clean image as learning data.

In a monitoring camera, a monitoring target is generally a moving subject (moving body). Therefore, in learning of the NN for noise reduction, it is desirable to use an image that is an actually captured image and that shows a moving body. However, in Patent Document 1, a foreground image is processed to generate a composite image in which it is pasted onto a background image, which does not necessarily result in an image that can be regarded as an actually captured image. In the method of Non-Patent Document 1, generating an appropriate clean image requires that a subject is stationary in a large number of noisy images to be subjected to averaging processing, and it is difficult to apply the method to a moving body.

### SUMMARY

The present disclosure provides a technique of generating a data set used for machine learning.

An information processing apparatus comprising: at least one processor; and at least one memory having stored thereon instructions which, when executed by the at least one processor, cause the information processing apparatus at least to: obtain a captured image obtained by an image capturing apparatus that can control an angle of view; generate an image pair including a noisy image including noise in an image and a clean image in which noise is reduced in an image, based on a plurality of captured images shot with an identical angle of view; control a plurality of image pairs corresponding to a plurality of angles of view different from each other so as to be generated by the generation unit; and add a label that can uniquely identify each image pair to each of the plurality of image pairs.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a hardware configuration of an information processing apparatus.

FIG. 2 is a view illustrating a functional configuration of a system (first embodiment).

FIG. 3 is a flowchart of data generation processing (first embodiment).

FIG. 4 is a view illustrating an outline of data generation processing.

FIG. 5 is a view illustrating a functional configuration of a system (second embodiment).

FIG. 6 is a flowchart of data generation processing (second embodiment).

FIG. 7 is a view describing mask creation processing.

FIG. 8 is a view illustrating a functional configuration of a system (third embodiment).

FIG. 9 is a flowchart of data generation processing (third embodiment).

FIG. 10 is a view describing generation processing of a noisy image by application of image processing.

FIG. 11 is a view describing addition of motion blur.

FIG. 12 is a view illustrating a functional configuration of a system (fourth embodiment).

FIG. 13 is a flowchart of additional learning (fourth embodiment).

FIG. 14 is a view describing the operation of a neural network.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As the first embodiment of an information processing apparatus according to the present disclosure, an information processing apparatus that generates an image pair (a noisy image and a clean image) usable for learning of a neural network that performs noise reduction will be described below as an example. In particular, a method of generating a plurality of image pairs suitable for learning of a moving subject (moving body) will be described.

### System Configuration

FIG. 2 is a view illustrating a functional configuration of a system in the first embodiment. A data generation system is for generating a data set usable for learning of a noise reduction model that achieves noise reduction by machine learning.

The data generation system includes an information processing apparatus 100, the image capturing apparatus 201, and the database 202. The image capturing apparatus 201 includes an image capturing unit 210 and a driving unit 211. The image capturing unit 210 can shoot an image using an optical system, an image capturing element, and the like. The driving unit 211 can control a shooting angle of view of the image capturing unit 210 by pan, tilt, and zoom operations (PTZ operations).

Here, it is assumed that the data generation system obtains and processes an image shot in an actual operation environment. For example, in monitoring at night by a monitoring camera system, an image shot by a camera (corresponding to the image capturing apparatus 201) tends to be dark. Therefore, the shot image is brightened by increasing the sensor sensitivity of the camera. On the other hand, when the sensor sensitivity is increased, noise is also amplified, and therefore visible noise is included in the image. Therefore, it is assumed that the data generation system obtains an image including noise and performs processing.

The information processing apparatus 100 includes an image generation unit 220 and a label addition unit 221. The image generation unit 220 obtains an image shot by the image capturing apparatus 201, and generates a “noisy image” in which noise is included in the image and a “clean image”, which has an identical scene to that of the noisy image and has noise reduced. The label addition unit 221 adds a label that can uniquely identify an image pair of a noisy image and a clean image corresponding to the noisy image that are generated by the image generation unit 220. The database 202 obtains, from the information processing apparatus 100, and stores an image pair to which a label is added by the information processing apparatus 100.

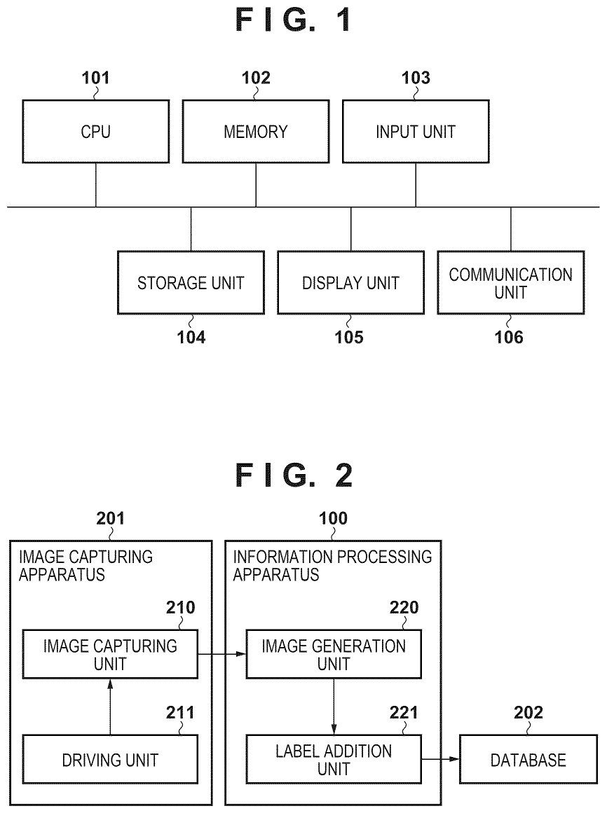

FIG. 1 is a view illustrating the hardware configuration of the information processing apparatus 100. The information processing apparatus 100 can be composed of a general-purpose information processing apparatus including a CPU 101, a memory 102, an input unit 103, a storage unit 104, a display unit 105, and a communication unit 106. For example, the CPU 101 achieves the image generation unit 220 and the label addition unit 221 by executing a program stored in the storage unit 104. Note that the image generation unit 220 and/or the label addition unit 221 may partially or entirely be implemented by hardware such as an application specific integrated circuit (ASIC).

### Apparatus Operation

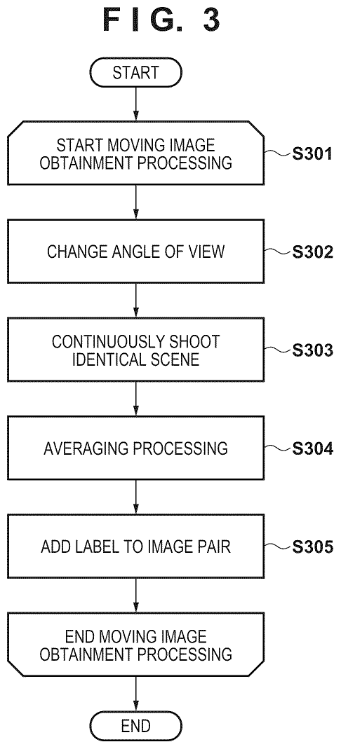

FIG. 3 is a flowchart of data generation processing in the first embodiment.

In S301, the image generation unit 220 starts processing for obtaining a moving image (a plurality of frame images) obtained by the image capturing apparatus 201. Thereafter, loop processing of S302 to S305 is repeatedly executed to generate a data set (a plurality of image pairs) to be used for learning.

In S302, the image generation unit 220 controls the driving unit 211 so as to change the angle of view (shooting range) of the image capturing unit 210. By this, the driving unit 211 changes the angle of view of the image capturing unit 210 by the operation such as pan, tilt, and zoom. At this time, the motion amount of the driving unit 211 in changing the angle of view and the motion amount on the shot image are associated with each other based on angle of view information (pan/tilt angle information and/or zoom magnification information) of the image capturing unit 210 that can be obtained in advance from the driving unit 211. A limit value is set in advance for the motion amount on the shot image, and the motion amount of the driving unit 211 is also limited in accordance with the limit value of the motion amount on the shot image. The angle of view is moved (e.g., randomly) within a limited motion amount range.

In S303, the image generation unit 220 controls the image capturing unit 210 so as to perform continuous shooting with the angle of view changed in S302, and obtains a large number of images (noisy images 401) obtained by the shooting. Here, it is assumed to obtain 1000 images as an example. Note that the number of noisy images to be obtained may be changed in accordance with the magnitude of noise. For example, since noise generally increases as the sensor sensitivity increases, the number of shot noisy images may be increased in proportion to the sensor sensitivity.

In S304, the image generation unit 220 generates one clean image 402 with reduced noise using the 1000 noisy images obtained in S303. For example, the image generation unit 221 generates one clean image by performing averaging processing on the 1000 noisy images. In a case where the subject in the 1000 noisy images is stationary, pixels at the same position in the plurality of images represent the same position of the same subject, and therefore it is possible to obtain the original pixel value not including noise by averaging variations in pixel values caused by noise.

In S305, the image generation unit 220 creates and outputs, to the label addition unit 305, an image pair in which the one clean image 402 and the one noisy image 401 generated in S304 are associated with each other. For example, as the one noisy image 401 to be used for the image pair, one of the 1000 noisy images may be randomly selected. However, a set in which a plurality of noisy images and one clean image are associated with each other may also be created.

In S305, the label addition unit 221 adds a label to the image pair created in S304, and stores the image pair in the database 202. The label to be added allows each image pair created by the loop processing of S302 to S305 to be uniquely identified. For example, information on the shooting time of the used image can be added as a label.

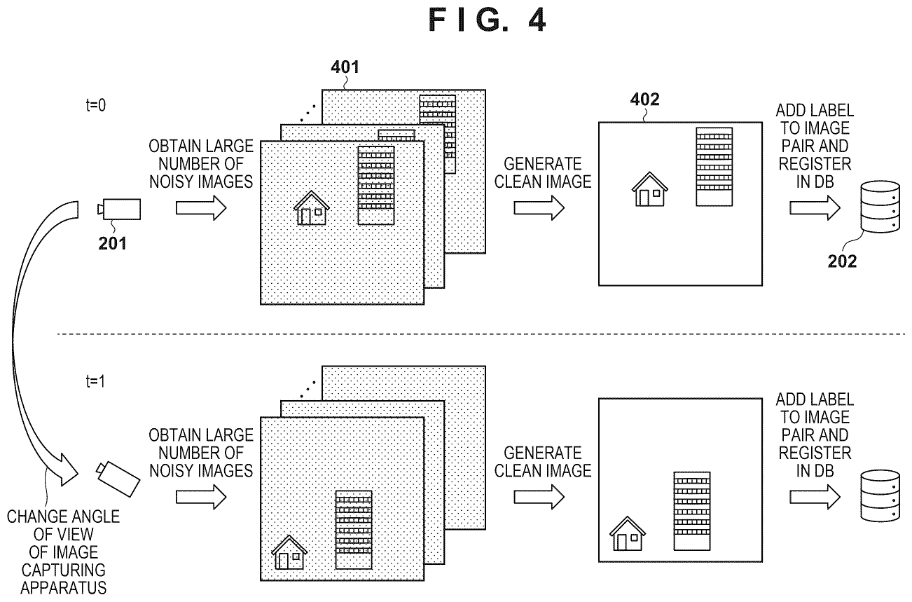

FIG. 4 is a view illustrating an outline of the data generation processing (loop processing of S302 to S305). For example, in the first loop (t=0), the image capturing unit 210 performs shooting with the initial angle of view. The initial angle of view may be a predetermined angle of view. In the second loop (t=1), the driving unit 211 changes the angle of view of the image capturing unit 210 by the PTZ operation, and the image capturing unit 210 performs shooting with the changed angle of view. Similarly in the third and subsequent loops, the angle of view of the image capturing unit 210 is changed and shooting is performed.

Note that in the above description of S302, the angle of view is changed within a limited motion amount range, but the motion amount may be changed without limitation. In this case, the image generation unit 220 obtains the angle of view information (pan/tilt angle information and/or zoom magnification information) of the image capturing unit 210 that can be obtained in advance from the driving unit 211. At the time of addition of the label in S305, the angle of view information may be added as a label.

As described above, according to the first embodiment, one image pair (a noisy image and a clean image) is generated based on a plurality of images shot by the image capturing apparatus for a certain angle of view. Then, every time the image pair is generated, the angle of view of the image capturing apparatus is controlled to be changed. By this, the subject position in the image changes in different image pairs. Therefore, a data set in which a plurality of image pairs generated in this manner are chronologically arranged can be regarded as a data set in which a moving subject (moving body) is shot. Therefore, use of the data set for learning a noise reduction model makes it possible to obtain a model that can suitably reduce noise from a frame image constituting a moving image in which a moving body is shot.

### Second Embodiment

In the second embodiment, a form in which, when a clean image is generated based on a plurality of noisy images, a mask indicating a region where the positions of a subject do not match (a region where the subject moves) is also generated in the plurality of noisy images will be described.

In the first embodiment described above, one clean image is generated by performing averaging processing on a plurality of noisy images. At this time, it is desirable that the subject in the plurality of images is at the same position (=the subject is stationary). In a case where a moving subject is included in the image, a correct pixel value cannot be restored only by performing averaging processing on the image alone. It is conceivable to align and perform averaging processing on a plurality of images, but in a case where noise is included in the images, it is generally difficult to align the images. Therefore, information on the mask for a region of the moving subject in the images is generated. Then, when the noise reduction model is learned, the region indicated by this mask is not learned.

### System Configuration

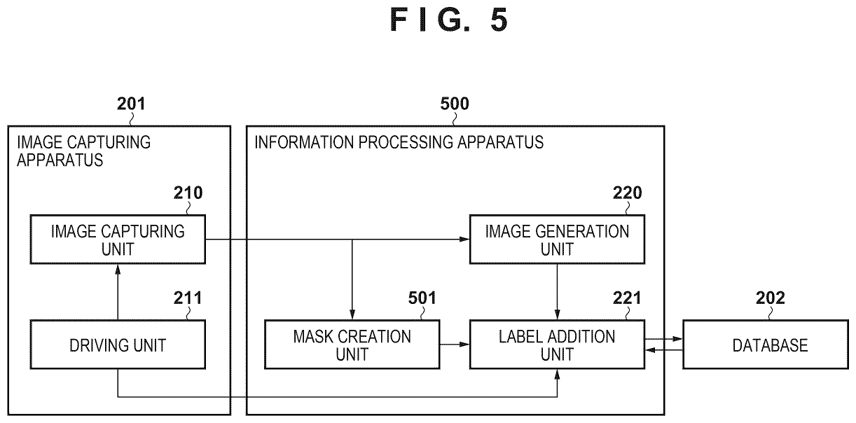

FIG. 5 is a view illustrating a functional configuration of a system in the second embodiment. The data generation system includes an information processing apparatus 500, an image capturing apparatus 201, and a database 202. An information processing apparatus 500 includes a mask creation unit 501 that creates a mask representing a region where a moving subject exists included in a shot image. Since the other apparatuses and functional units have similar functions to those described in the first embodiment, the description thereof will be omitted.

### Apparatus Operation

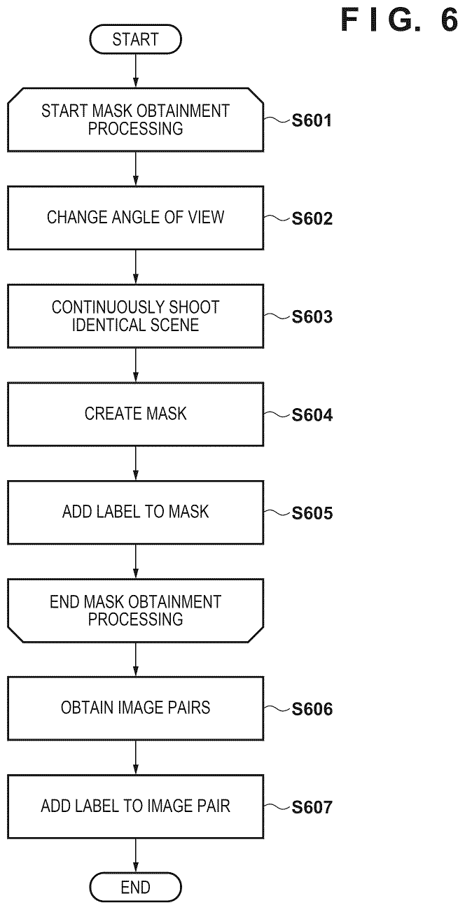

FIG. 6 is a flowchart of data generation processing in the second embodiment.

In S601, the mask creation unit 501 starts processing of obtaining a mask to be used for learning a noise reduction model. Thereafter, loop processing of S602 to S605 is repeatedly executed to generate a mask to be used for learning.

In S602, the mask creation unit 501 controls the driving unit 211 so as to change the angle of view (shooting range) of the image capturing unit 210. By this, the driving unit 211 changes the angle of view of the image capturing unit 210 by the operation such as pan, tilt, and zoom. That is, it is similar to S302 of the first embodiment. Information on the angle of view of the image capturing unit at this time is output to the label addition unit 221.

In S603, the mask creation unit 501 controls the image capturing unit 210 so as to perform continuous shooting with the angle of view changed in S602, and obtains a large number of images obtained by the shooting. Here, it is assumed to obtain 1000 images as an example. It is assumed that the processing of S603 is performed in a time period (daytime or the like) when noise is less likely to occur in the captured image and the subject is bright.

In S604, using the large number of images obtained in S603, the mask creation unit 501 detects a moving region in the image to create a mask representing the moving region. The created mask is output to the label addition unit 221.

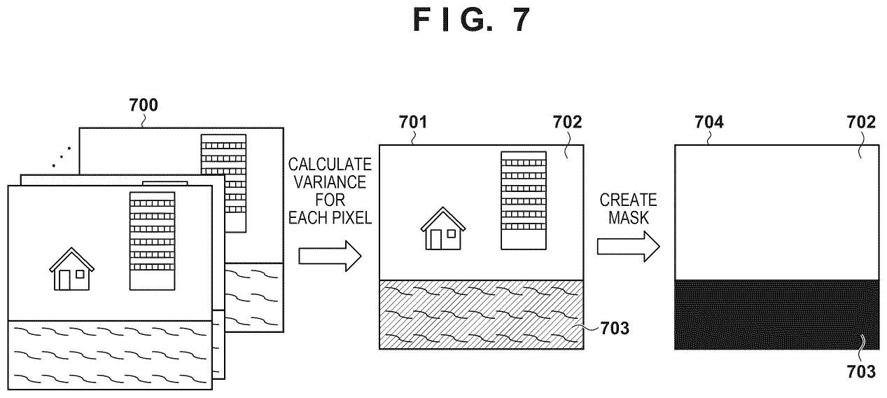

FIG. 7 is a view describing mask creation processing (S604). First, the variance of pixel values at each pixel position in the image is calculated using a large number (here, 1000) of shot images 700 having been obtained. A map 701 of variance values is obtained by generating an image in which the variance values calculated here are used as pixel values. In this map, a region with little motion is a region 702 with a small variance value, and a region with large motion (e.g., sea generating violent waves) is a region 703 with a large variance value. A threshold for the variance value is provided in advance, and a mask is created with a pixel position where the variance value exceeds the threshold having a value of 0 and a pixel position where the variance value falls below the threshold having a value of 1. By this, a mask 704 corresponding to the magnitude of the motion is generated.

In S605, the label addition unit 221 adds a label to the mask created in S604, and stores the label in the database 202. The label to be added allows each mask created by the loop processing of S602 to S605 to be uniquely identified. For example, a label representing information on the angle of view (shooting range) of the image capturing unit 210 when an image used to create the mask is shot is added as a label.

By repeatedly executing the loop processing of S602 to S605 described above, it is possible to create a mask (a moving region in the image) in images shot at various angles of view.

In S606, the information processing apparatus 500 generates an image pair of a noisy image and a clean image. That is, it is similar processing to that of the first embodiment (FIG. 3). However, the pair to be generated at this time is generated from an image shot with the angle of view of the image capturing unit 210 when the mask is obtained. By this, an image pair having the same angle of view as that of the created mask is obtained.

In S607, the label addition unit 221 adds a label to the image pair obtained in S606. At this time, a label similar to that of the mask having the same angle of view stored in the database 202 is added. This adds a label that can uniquely identify an image pair (a noisy image and a clean image) and a mask as a set. Then, the image pair to which the label is added is stored in the database 202.

As described above, according to the second embodiment, information on the mask for a region where the subject positions do not match (a region of the moving subject) in a plurality of images used for generation of one image pair is generated. Then, the image pair and the mask are stored in association with each other. Then, when a noise reduction model is learned using an image pair, it is possible to obtain a suitable noise reduction model by not learning the region of a corresponding mask.

Note that in the second embodiment, a method of obtaining the variance of pixel values at each pixel position has been described as a method of specifying the region of a moving subject, but the method of specifying the region of a moving subject may be other methods. For example, an image region of a moving object may be specified by an object recognition model learned in advance, and a region including the region may be a mask region.

### Third Embodiment

In the third embodiment, a method of generating an image pair of a noisy image and a clean image for which image processing is applied will be described. Hereinafter, an example of adding motion blur to a clean image and generate a noisy image to which noise is added will be described.

### System Configuration

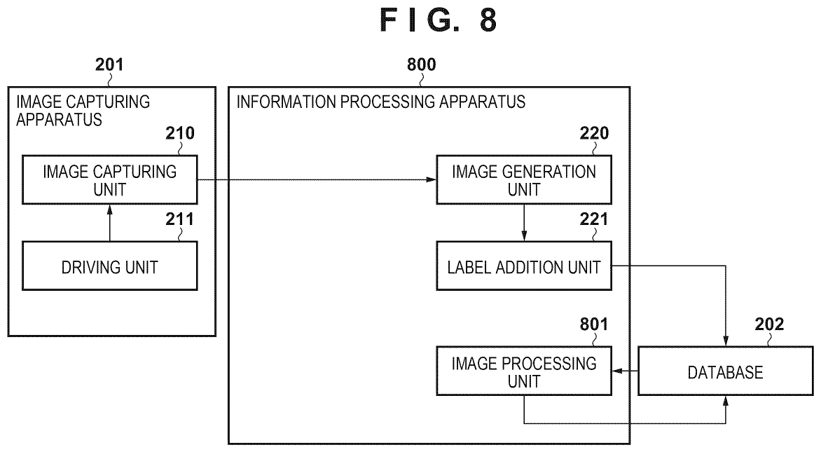

FIG. 8 is a view illustrating a functional configuration of a system in the third embodiment. The data generation system includes an information processing apparatus 800, the image capturing apparatus 201, and the database 202. The information processing apparatus 800 includes an image processing unit 801 that executes image processing on an image. Since the other apparatuses and functional units have similar functions to those described in the first embodiment, the description thereof will be omitted.

### Apparatus Operation

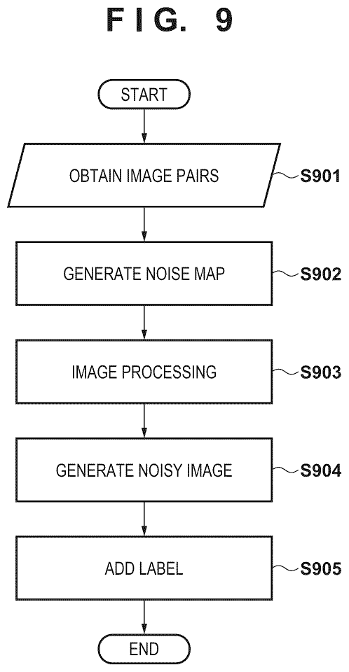

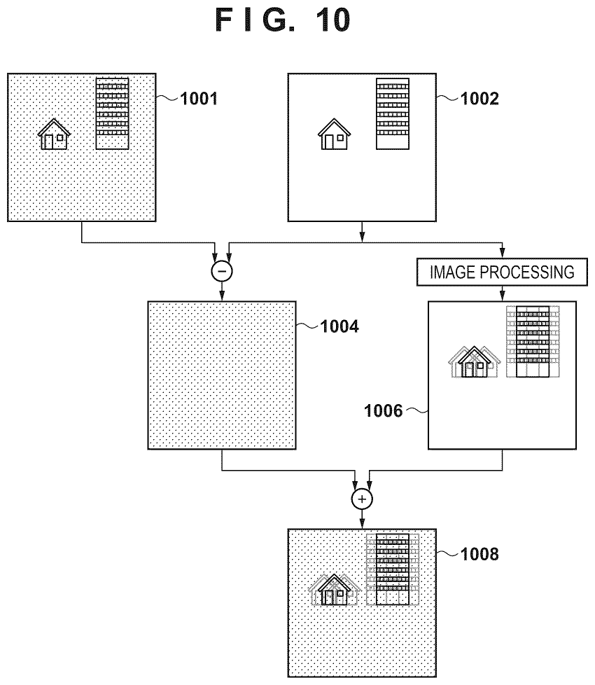

FIG. 9 is a flowchart of data generation processing in the third embodiment. FIG. 10 is a view describing generation processing of a noisy image by application of image processing. Note that here, a state where a plurality of image pairs are stored in the database 202 by the processing of the first embodiment is assumed.

In S901, the image processing unit 801 obtains one image pair (a noisy image 1001 and a clean image 1002) stored in the database 202.

In S902, the image processing unit 801 calculates a difference between the noisy image 1001 and the clean image 1002. By this, a difference image map in which only noise included in the noisy image is extracted is obtained. This map is referred to as a noise map 1004.

In S903, the image processing unit 801 performs given image processing on the clean image to create a clean image 1006. In the present embodiment, motion blur is added as an example of image processing. Motion blur is blur of a subject due to motion occurring in an image. In the present embodiment, motion blur occurring in a moving subject is artificially added, thereby improving reproducibility as a moving image (a plurality of frame images) of the moving subject.

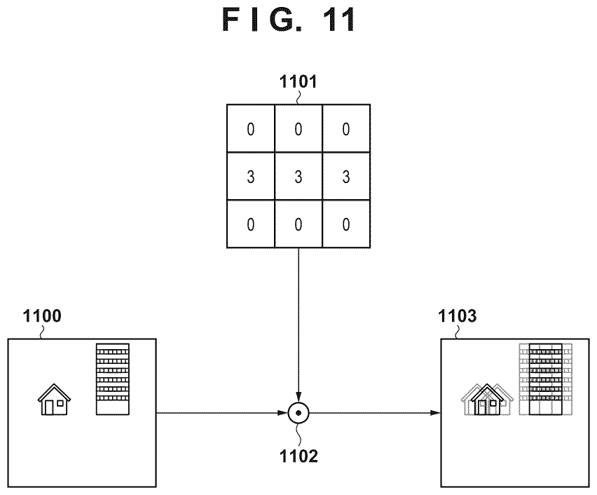

FIG. 11 is a view describing motion blur adding processing. A kernel 1101 (here, addition of blur in the lateral direction) that causes motion blur is prepared in advance, and a convolution operation 1102 between an image 1100 and the kernel 1101 is performed, thereby generating a motion blur added image 1103 (blurred image).

Note that the image processing applied to the clean image is not limited to motion blur, and various types of image processing can be used. In particular, image processing that is difficult to apply to a noisy image can be used. For example, when motion blur is applied to a noisy image, noise is also blurred, the noise is reduced by pixel value averaging in a spatial direction, and the noisy image cannot be used as a noisy image used for learning. On the other hand, by applying motion blur to a clean image and adding a noise map described later, a noisy image in which motion blur exists can be artificially generated. Other than this, image processing such as optical blur and aberration correction is similarly processing that changes characteristics such as a shape and a color of noise, and therefore is image processing that should not be applied to a noisy image.

In S904, the image processing unit 801 generates a noisy image 1008 by adding the noise map 1004 to the clean image 1006. This processing makes it possible to obtain the noisy image 1008 for which the image processing (here, motion blur) is applied while maintaining the noise characteristics.

In S905, the label addition unit 221 adds a label to the image pair of the noisy image 1008 and the clean image 1006, and stores the image pair in the database 202.

As described above, according to the third embodiment, an image pair of a noisy image and a clean image for which image processing is applied is generated. By using a data set including such an image pair for learning, it is possible to obtain a model for improving image quality.

### Fourth Embodiment

In the fourth embodiment, a form of additionally learning a noise reduction model in a video monitoring system in which a noise reduction model is incorporated will be described.

### System Configuration

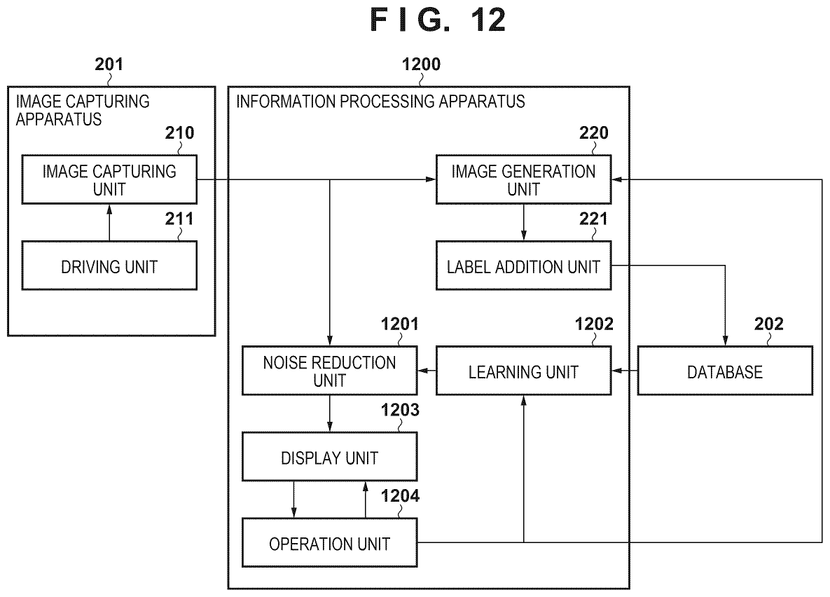

FIG. 12 is a view illustrating a functional configuration of a system in the fourth embodiment. The system includes an information processing apparatus 1200, the image capturing apparatus 201, and the database 202. The information processing apparatus 1200 further includes a noise reduction unit 1201 and a learning unit 1202. The noise reduction unit 1201 reduces noise from a moving image (a plurality of frame images) obtained from the image capturing apparatus 201 using a learned noise reduction model. The learning unit 1202 executes additional learning on the noise reduction model used in the noise reduction unit 1201. The information processing apparatus 1200 may include a display unit 1203 and an operation unit 1204. The display unit 1203 displays a moving image obtained from the image capturing apparatus 201 and displays a user interface (UI) that receives an operation from the user. The operation unit 1204 receives, from the user, an operation for the UI displayed on the display unit 1203. Since the other apparatuses and functional units have similar functions to those described in the first embodiment, the description thereof will be omitted.

Note that as a noise reduction model by machine learning, one based on a convolutional neural network (CNN) as described in Document A can be used. The CNN is composed of a large number of convolutional layers and activation functions. In particular, a network called U-Net having a U-shaped structure is used as a neural network that achieves image quality enhancement image processing such as noise reduction and super resolution. The network in Document A also performs noise reduction using the U-Net. Also the present embodiment uses a structure based on the U-Net used in Document A.
Document A: Matias Tassano et al., “DVDNet: A Fast Network for Deep Video Denoising”, arXiv:1906.11890v1, 2019

### Apparatus Operation

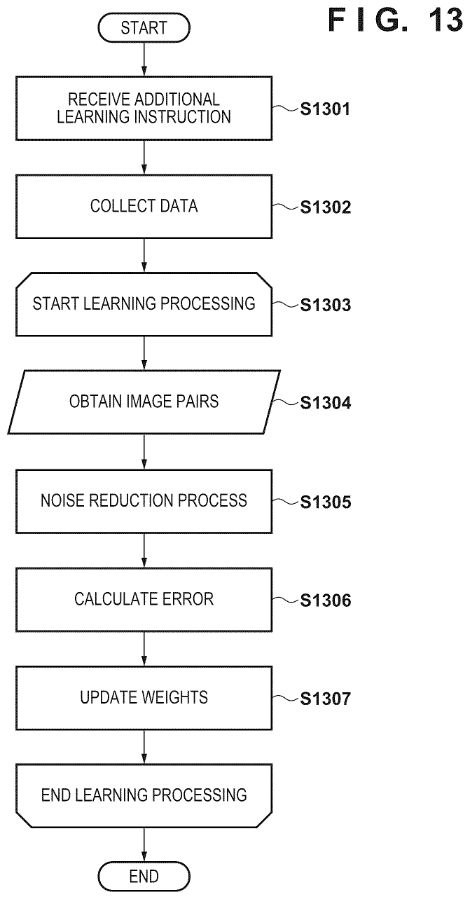

FIG. 13 is a flowchart of additional learning in the fourth embodiment.

In S1301, the operation unit 1204 receives an instruction for additional learning from the user. For example, when the user presses a button for starting processing of the additional learning displayed on the display unit 1203, the subsequent processing is started.

Note that the system may be configured to automatically start execution of the additional learning processing without receiving a user operation. For example, the additional learning processing may be started at a designated time.

In S1302, the information processing apparatus 1200 generates an image pair of a noisy image and a clean image. That is, it is similar processing to that of the first embodiment (FIG. 3). Note that the image pair may be stored in the database 202 in advance, and the image pair may be obtained therefrom.

In S1303, the learning unit 1202 starts learning of the NN. Update of a plurality of parameters such as a network weight and a bias is repeatedly executed by the learning processing.

In S1304, the learning unit 1202 obtains a plurality of image pairs (noisy images and clean images) from the database 202. Here, the number of image pairs necessary for one inference of the noise reduction model is obtained. The image pair obtained at this time is obtained based on the label added when stored in the database 202. In the first embodiment, labels are added to image pairs in the order of time when images are shot. Therefore, as many image pairs as necessary for learning are obtained in the order of shooting time.

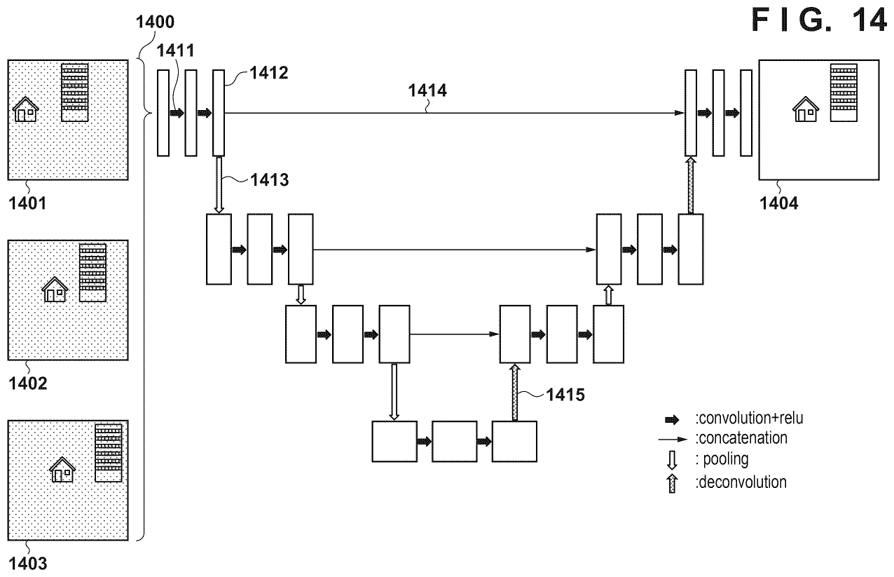

FIG. 14 is a view describing the operation of the neural network (NN) of the noise reduction model. Upon inputting a plurality of images that are chronologically consecutive, the NN outputs a noise reduction image for the image at the middle time among the plurality of input images in which noise has been reduced from the image. Here, an input 1400 in which three captured images (noisy images 1401, 1402, and 1403) at time points t=0, 1, and 2 chronologically consecutive are concatenated in a channel direction is used. The output of the NN is configured so as to output a noise reduction image at time t=1.

At this time, the noisy images obtained by the learning unit 1202 in S1304 are the noisy images 1401, 1402, and 1403. The clean image obtained by the learning unit 1202 in S1304 is a clean image (GT) corresponding to the noisy image of t=1.

In S1305, the noise reduction unit 1201 obtains a noise reduction image 1404 by inputting, to the noise reduction model, the noisy images and the clean image obtained in S1304. The obtained noise reduction image 1404 is output to the learning unit 1202.

The mechanism of inference by the neural network in FIG. 14 will be described. Here, it is assumed that U-Net is used as a neural network. The U-Net is composed of an encoder that generates a feature amount while compressing an image, and a decoder that restores an image from the compressed feature amount.

First, the encoder generates feature amounts having different resolutions and different numbers of channels from the input 1400. The network applies, to the input 1400, processing 1411 of applying a convolution operation and a relu function a plurality of times, and generates a feature amount 1412. The resolution of the generated feature amount 1412 is reduced by pooling processing 1413. Thereafter, the convolution operation and the relu function are repeated again to obtain a feature amount having an increased number of channels. The feature amount 1412 generated at this time is used at the time of image restoration processing described later, and is subjected to skip concatenation 1414 with another feature amount generated while being upsampled.

By performing deconvolution operation 1415 on the compressed feature amount by repeating a series of processing, the feature amount is restored to the image while reducing the number of channels and increasing the resolution. At this time, the feature amount upsampled in deconvolution processing is subjected to skip concatenation with a feature amount generated by the encoder, and a plurality of convolution operations, application of the relu function, and the deconvolution processing are repeatedly executed. Finally, the noise reduction image 1404 having a desired resolution and number of channels is output.

As described above, the noise reduction image 1404 is an image for which noise has been reduced from the noisy image 1402. In the present embodiment, a network configured as described above is used, but the structure is not limited as long as the network can achieve noise reduction from the image.

In S1306, the learning unit 1202 calculates an error using the clean image (GT) obtained in S1304 and the noise reduction image obtained in S1305. Here, an L1 error represented by the following Formula (1) is used as an error. In Formula (1), Îₜ is a noise reduction image, and It is a clean image (GT).

$${L}_{i} = \vert {I}_{t} - {\hat{I}}_{t} \vert \qquad ( 1 )$$

In S1307, the learning unit 1202 updates the weights of the noise reduction model by an error back-propagation method using the error calculated in S1306. The above processing of S1304 to S1307 is repeatedly performed, and additional learning of the neural network that executes noise reduction is performed.

As described above, according to the fourth embodiment, in a video monitoring system, a noise reduction model can be additionally learned using a moving image in an actual operation environment. Since the model is learned using data of the actual operation environment, the noise reduction performance can be efficiently improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-231015, filed Dec. 26, 2024, which is hereby incorporated by reference herein in its entirety.

What is claimed is:

1. An information processing apparatus comprising:
at least one processor; and
at least one memory having stored thereon instructions which, when executed by the at least one processor, cause the information processing apparatus at least to:
obtain a captured image obtained by an image capturing apparatus that can control an angle of view;
generate an image pair including a noisy image including noise in an image and a clean image in which noise is reduced in an image, based on a plurality of captured images shot with an identical angle of view;
control a plurality of image pairs corresponding to a plurality of angles of view different from each other so as to be generated by the generation unit; and
add a label that can uniquely identify each image pair to each of the plurality of image pairs.

2. The information processing apparatus according to claim 1, wherein
a plurality of captured images are obtained for each of the plurality of angles of view and
the plurality of image pairs corresponding to each of the plurality of angles of view are generated.

3. The information processing apparatus according to claim 1, wherein
an angle of view of the image capturing apparatus is further controlled.

4. The information processing apparatus according to claim 1, wherein
information regarding a time at which a plurality of captured images used for generation of an image pair are shot is added, as the label, to each of the plurality of image pairs.

5. The information processing apparatus according to claim 1, wherein
information regarding an angle of view of a plurality of captured images used for generation of an image pair is added, as the label, to each of the plurality of image pairs.

6. The information processing apparatus according to claim 1, wherein
the clean image is generated by performing averaging processing on the plurality of captured images.

7. The information processing apparatus according to claim 1, wherein
a mask indicating a region in which positions of a subject do not match in a plurality of captured images shot with an identical angle of view is further created.

8. The information processing apparatus according to claim 7, wherein
the mask is created based on a variance of pixel values of the plurality of captured images at each pixel position of the plurality of captured images.

9. The information processing apparatus according to claim 7, wherein
a same label as a label of a corresponding image pair is further added to each mask corresponding to each of the plurality of image pairs.

10. The information processing apparatus according to claim 1, wherein
based on a noisy image and a clean image included in the image pair, a second image pair including a second noisy image and a second clean image is generated.

11. The information processing apparatus according to claim 10, wherein
a difference image is generated based on a difference between a noisy image and a clean image included in the image pair, given image processing is performed on the clean image to generate the second clean image, and the difference image and the second clean image are added to generate the second noisy image.

12. The information processing apparatus according to claim 11, wherein
the given image processing is motion blur adding processing.

13. A learning apparatus that performs learning of a noise reduction model for reducing noise included in an image, the learning apparatus comprising:
a learning unit that performs learning of the noise reduction model using a plurality of image pairs generated by the information processing apparatus according to claim 1.

14. A control method of an information processing apparatus that generates a plurality of image pairs used for learning of a noise reduction model for reducing noise included in an image, the control method comprising:
obtaining a captured image obtained by an image capturing apparatus that can control an angle of view;
generating an image pair including a noisy image including noise in an image and a clean image in which noise is reduced in an image, based on a plurality of captured images shot with an identical angle of view;
controlling a plurality of image pairs corresponding to a plurality of angles of view different from each other so as to be generated by the generating; and
adding a label that can uniquely identify each image pair to each of the plurality of image pairs.

15. A non-transitory computer-readable recording medium storing a program that, when executed by a computer, causes the computer to perform a control method of an information processing apparatus that generates a plurality of image pairs used for learning of a noise reduction model for reducing noise included in an image, the control method comprising:
obtaining a captured image obtained by an image capturing apparatus that can control an angle of view;
generating an image pair including a noisy image including noise in an image and a clean image in which noise is reduced in an image, based on a plurality of captured images shot with an identical angle of view;
controlling a plurality of image pairs corresponding to a plurality of angles of view different from each other so as to be generated by the generating; and
adding a label that can uniquely identify each image pair to each of the plurality of image pairs.
